(19) United States
(12) Patent Application Publication
(10) Pub. No.: US 2025/0001598 A1
(43) Pub. Date: Jan. 2, 2025

(54) COBOT WELDING TRAJECTORY CORRECTION WITH SMART VISION

(71) Applicant: American Air Liquide, Inc., Fremont, CA (US)

(72) Inventors: Zongyao Chen, Aston, PA (US); Jean-Pierre Planckaert, Monneville (FR)

(21) Appl. No.: 18/214,961

(22) Filed: Jun. 27, 2023

(51) Int. Cl. B25J 9/16; B23K 37/02; G06T 7/13; G06T 7/246

(52) U.S. Cl. CPC B25J 9/1664; B23K 37/0229; B25J 9/1697; G06T 7/13; G06T 7/251; G06T 2207/30108; G06T 2207/30241

(57) ABSTRACT

A compact vision-sensing device for a robotic welding arm, having a high-resolution camera, a multi-color light source configured to have multi-color selectivity, and a means of dust and welding fume protection configured to automatically close and protect the high-resolution camera and multi-color light source during a welding operation.

### BACKGROUND

The increasing shortage of experienced welders has become a concern for manufacturing globally. Automated robotic welding plays an essential role in most large manufacturing companies. Due to safety concerns, the user must often install a welding robot arm in a place that is unsafe for humans, and program the welding trajectory through a teaching pendant. The safety equipment, such as a pre-engineered work cell, started at $50,000.

Collaborative robots or ‘cobots’ are robot arms that work with human beings. The cobot system takes less setup time than a robot welding system. The human operators can adjust the cobot arm pose manually with their hands. The features like customizable stop time and stop distance limits in the cobot joints can ensure safety when cobots work with operators.

The universal robot is one of the most popular collaborative robots in the market. Commercially available cobots address the skilled labor shortage by allowing companies to “hire” easy-to-use automated welding labor through short or long-term rental or lease programs.

The user teaches the welding trajectory for the current cobot welding system before welding. The user needs to move the cobot arm, record each weld's start and end pose, and repeat the trajectory during welding. In many cases, the welder must conduct repeated welds on workpieces of the same shape and size. The welder must ensure each workpiece is placed in the same position as the reference one. The welder must change the pre-programmed trajectory if any displacement is introduced by loading a new part.

The parts repositioning error may cause misalignment with the taught trajectory for repeating welding tasks. Without machine vision, the robot is blind and needs to be programmed and led by operators. The user must adjust the welding trajectory based on the current workpiece position.

Hence, developing vision capacity is a major task to improve the intelligence of the existing cobot welding system and automatically correct human errors. The vision guide universal robot was developed for pin-picking and has been applied in the industry (see for example US patent U.S. Pat. No. 9,079,308). However, the welding process needs much higher repeat accuracy than the pin-picking task. Currently, there is no cobot welding system with a vision sensor on the market.

Although a few companies, such as servo Robot and Binzal, have developed laser-based guided vision systems for welding seam finding and tracking, the cost of each unit is more than 20K. This invention disclosed the vision-guided cobot welding system for welding trajectory correction based on a single 2D vision camera. It significantly reduced the cost of implementation compared to previous inventions. And it can increase the efficiency of the end user by reducing the teaching time.

### SUMMARY

A compact vision-sensing device for a robotic welding arm, having a high-resolution camera, a multi-color light source configured to have multi-color selectivity, and a means of dust and welding fume protection configured to automatically close and protect the high-resolution camera and multi-color light source during a welding operation.

### BRIEF DESCRIPTION OF THE FIGURES

For a further understanding of the nature and objects for the present invention, reference should be made to the following detailed description, taken in conjunction with the accompanying drawings, in which like elements are given the same or analogous reference numbers and wherein:

FIG. 1 is a schematic representation of a typical cobot welding cell as known in the art,

FIG. 2a is a schematic representation of the components of a robot arm in accordance with one embodiment of the current invention.

FIG. 2b is a schematic representation of the components of a robot arm in accordance with one embodiment of the current invention.

FIG. 3a is a schematic representation of the components of the vision-sensing device in accordance with one embodiment of the current invention.

FIG. 3b is a schematic representation of the components of the vision-sensing device in accordance with one embodiment of the current invention.

FIG. 4 is a schematic representation of a typical cobot welding cell in accordance with one embodiment of the current invention.

FIG. 5a is a schematic representation of the calibration procedure in accordance with one embodiment of the current invention.

FIG. 5b is a schematic representation of the calibration procedure in accordance with one embodiment of the current invention.

FIG. 6a is a schematic representation of first model generation option, wherein the software interface will require the user to select the point along the edge of the target workpiece in the image, in accordance with one embodiment of the present invention.

FIG. 6b, is a schematic representation of the welding waypoints, in accordance with one embodiment of the present invention.

FIG. 7a is a schematic representation of second model generation option, wherein the boundary of the workpieces is automatically generated in the image with an image-processing algorithm, which requires a uniform background, in accordance with one embodiment of the current invention.

FIG. 7b is a schematic representation of second model generation option, wherein the boundary of the workpieces is automatically generated in the image with an image-processing algorithm, which requires a uniform background, in accordance with one embodiment of the current invention.

FIG. 8a is a schematic representation of reference trajectory procedure in accordance with one embodiment of the current invention.

FIG. 8b is a schematic representation of reference trajectory procedure in accordance with one embodiment of the current invention.

FIG. 9 is a flowchart representation of the basic steps required for the application of an automatic trajectory for repeatable welding tasks, in accordance with one embodiment of the current invention.

FIG. 10 is a flowchart representation of the basic steps required for the application of an automatic trajectory for welding tasks involving multiple objects, in accordance with one embodiment of the current invention.

### ELEMENT NUMBERS

101=control system
102=power source
103=robot arm
104=worktable
105=item to be welded
106=power source interface communication
107=hose package
108=robot arm interface communication cable
109=teach pendant
201=base plate (of robot arm)
202=shoulder (of robot arm)
203=shoulder joint (of robot arm)
204=upper arm (of robot arm)
205=elbow joint (of robot arm)
206=lower arm (of robot arm)
207=wrist joint (of robot arm)
208=wrist (of robot arm)
209=welding torch
210=weld wire holder
211=weld wire conduit
212=wire feeder
213=torch cable
214=vision-sensing device
301=camera (and lens)
302=polarizing filter
303=automatic lens cap
304=light source4
305=camera shell
401=vision-sensing interface communication cable
501=calibration plate
701=white or dark image sheet
801=first workpiece
802=second workpiece

### DESCRIPTION OF PREFERRED EMBODIMENTS

Illustrative embodiments of the invention are described below. While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

In this invention, we developed an intelligent vision-guided cobotic welding system that can automatically locate the object in the workpiece and adjust the welding trajectory to make a weld. For repeated welding tasks, the computer vision algorithms can automatically correct any displacement error caused by loading the new part. The intelligent vision system also finds multiple welding workpieces in the workspace and calculates the welding trajectory for each one which highly reduces the programming time for the operators.

Available systems can perform fully automated arc welding (GMAW) with various shielding gas, filler metals, and base metals. A typical system can perform automatic welding tasks on various materials, including carbon steels, stainless steels, aluminum alloys, nickel-based alloys, and titanium alloys.

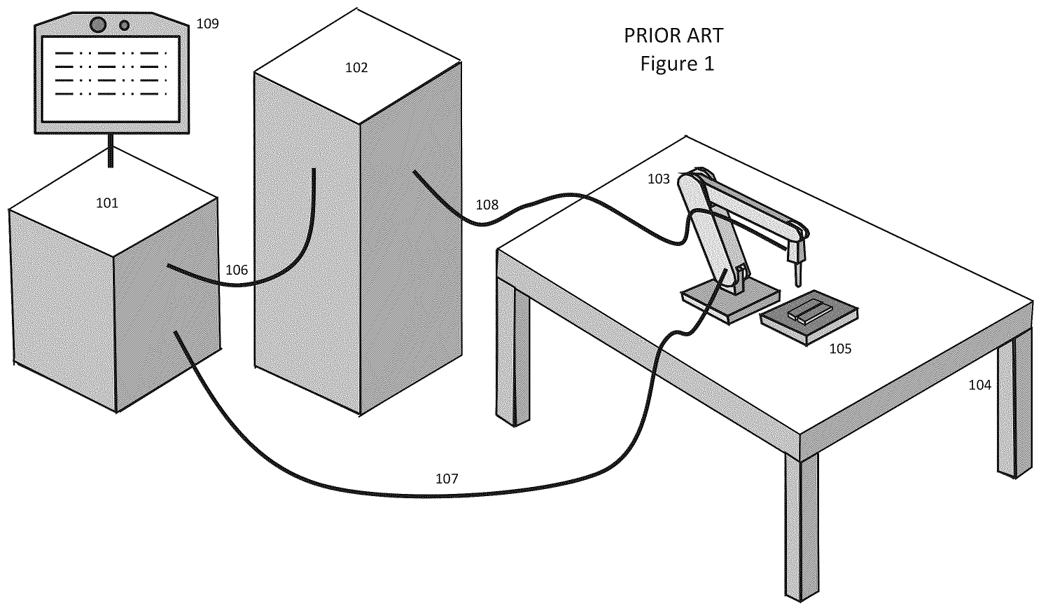

Turning to FIG. 1 a typical cobot welding cell as known in the art is presented. Control system 101 controls both power source 102 and robot arm 103 to make them work simultaneously in the frame of a welding strategy. Control system 101 controls the trajectory of robot arm 103 and power source 102 controls the welding parameters (amperage, voltage, wire-feeding speed). Power source 102 controls all consumables (gas and wire). Robot arm 103 will typically be attached to a worktable or bench 104, whereupon item 105 to be welded will be positioned. Control system 101 is functionally connected to power source 102 my means of power source interface communication cable 106. Power source 102 is functionally connected to robot arm 103 by means of hose package 107. Control system 101 may be functionally connected to robot arm 103 by means of robot arm interface communication cable 108. Typically, the operator provides input to control system 101 by means of teach pendant 109.

The cobot can be summarized as a high-end torch handler with all safety features (interlocks) embedded. The operator may use mobile devices such as smartphones to program the moving pass instead of using the original teach pendant.

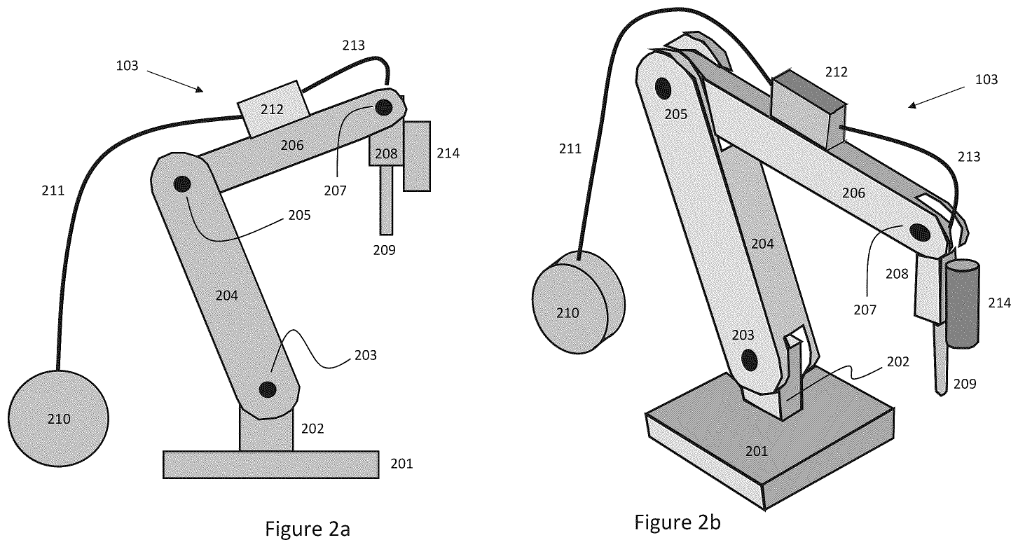

FIGS. 2a and 2b illustrate the components of robot arm 103 in accordance with one embodiment of the current invention. Base plate (sometimes referred to as the waist) 201 is affixed to the worktable or workbench (not shown), and to shoulder 202. Shoulder 202 is attached to upper arm 204 at shoulder joint 203. Upper arm 204 is attached to lower arm 206 at elbow joint 205. Lower arm 206 is attached to wrist 208 at wrist joint 207. Welding torch 209 is attached to wrist 208. Weld wire holder 210 may be attached to upper arm 204, or to some other location that is functionally acceptable. Weld wire conduit 211 is locate between weld wire holder 210 and wire feeder 212 and provides the conduit for the wire to travel to the feeder. Weld wire conduit 211 passes through wire feeder 212 and is typically then referred to as torch cable 213. Weld wire 211 and torch cable 213 are the same cable. Torch cable (sometimes referred to as a whip) 213 connects welding torch 209 with weld wire holder 210 and provides wire to the torch. Vision-sensing device 214 may be attached to lower arm 206, to wrist 208, or welding torch 209 facing the working bench (not shown)

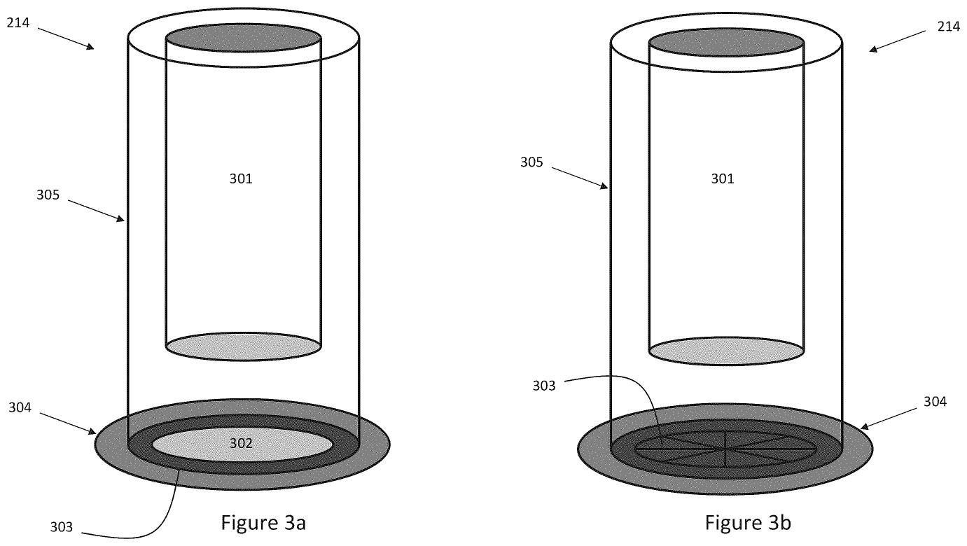

FIGS. 3a and 3b illustrate the component of vision-sensing device 214, in accordance with one embodiment of the current invention. Camera (and lens) 301 is located inside camera shell 305. Camera 301 may be a digital camera designed to capture and process a two-dimensional map of reflected intensity or contrast. Camera 301 may be used to evaluate the color, size, shape or location of item 105 to be welded. Camera shell 305 is designed to protect the vision sensors camera and lens 301 from spatters and welding fumes during operation. Automatic lens cap 303 is a front lens cover that automatically opens and closes. In FIG. 3a automatic lens cap 303 is open, and in FIG. 3b automatic lens cap 303 is closed. This opening and closing is controlled by control system 101. Camera and lens 301 is connected to control system 101 through an ethernet cable (not shown).

Light source 304 may be added to the outside of camera shell 305 and may be able to vary colors. A typical machine vision system utilizes ambient, white light. This is not always ideal but is obviously readily available. Multi-wavelength (RGB) lights may be used to facilitate optimal contrast and visibility. Light source 304 may have multi-color selectivity. In some cases, a red source, such as a red LED, may be best as they often correspond with the peak sensitivity of the camera's sensor. Polarizing filter 302 may be added if necessary.

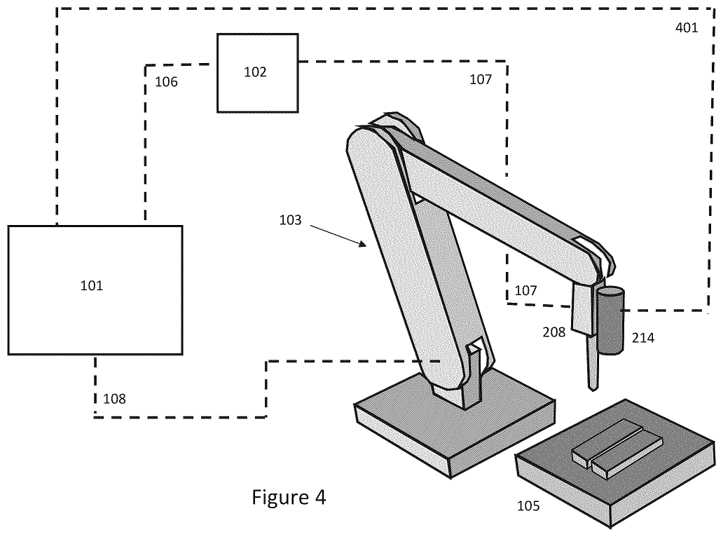

FIG. 4 lustrates a typical cobot welding cell in accordance with the current invention. Control system 101 controls both power source 102 and robot arm 103. Control system 101 is functionally connected to power source 102 my means of power source interface communication cable 106. Power source 102 is functionally connected to robot arm 103 by means of hose package 107. Control system 101 may be functionally connected to robot arm 103 by means of robot arm interface communication cable 108. Control system 101 may be functionally connected to vision-sensing device 214 by means of vision-sensing interface communication cable 401.

The main procedures for welding with a vision-guided cobot include four steps:
I. vision system calibration,
II. model generation,
III. reference trajectory programming, and
IV. vision-guided welding.

### I. Vision System Calibration

The vision system calibration and model generation are performed before welding. The vision system must be calibrated or recalibrated under the following conditions:
1. first installation of the camera,
2. the camera position on the cobot is moved,
3. the working distance between the camera and the target workpiece is changed, and the lens focus also needs adjustment.

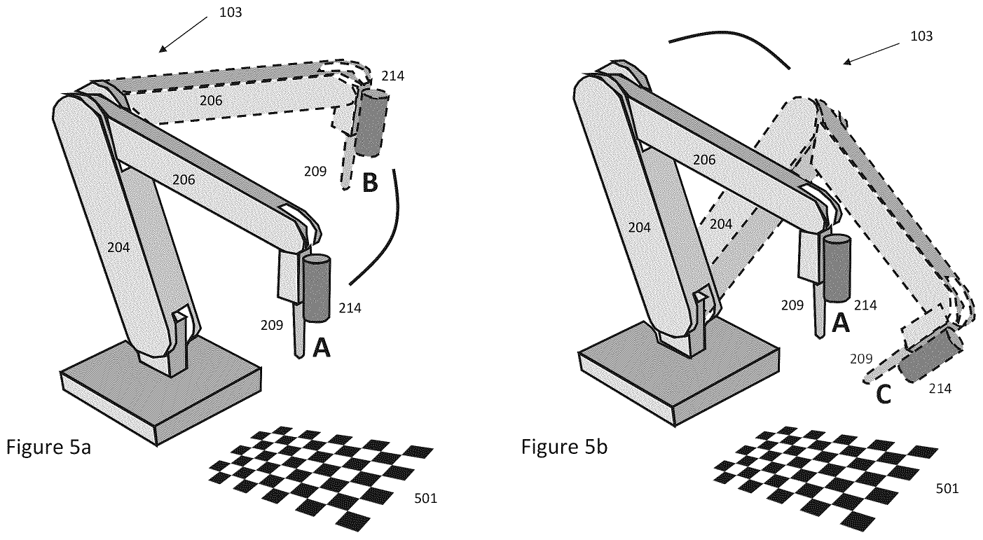

Turning to FIGS. 5a and 5b, the user starts the following calibration procedure after the camera installation. First, robot arm 103 is moved into an initial image acquisition position (Position A). Calibration plate 501 is positioned in front of robot arm 103. Calibration plate 501 is a target painted with special patterns which is recognizable by the control system. Camera 214 is focused and the first image of calibration plate 501 is made. Robot arm 103 is then moved (Position B or Position C) to change the visual angle of calibration plate 501, and multiple images are taken of the target from different positions. Intrinsic camera parameters are then calculated based on these images. Intrinsic camera parameters include the focal length, the optical center, and the skew coefficient. These intrinsic parameters are used to map the coordinates of calibration plate 501 into an image plane. Multiple images of calibration plate 501 must be taken from different camera poses and positions. Extrinsic camera parameters are then calculated based on these images. Extrinsic camera parameters include rotation, translation and the origin of the camera's coordinate system at the optical center. The relative position of baseplate 201 is determined.

### II. Model Generation

To define the object in the 2D image, a predefined 2D model is created which describes the shape of the part. There are two basic approaches to making a model.

### IIA: Target Edge Point

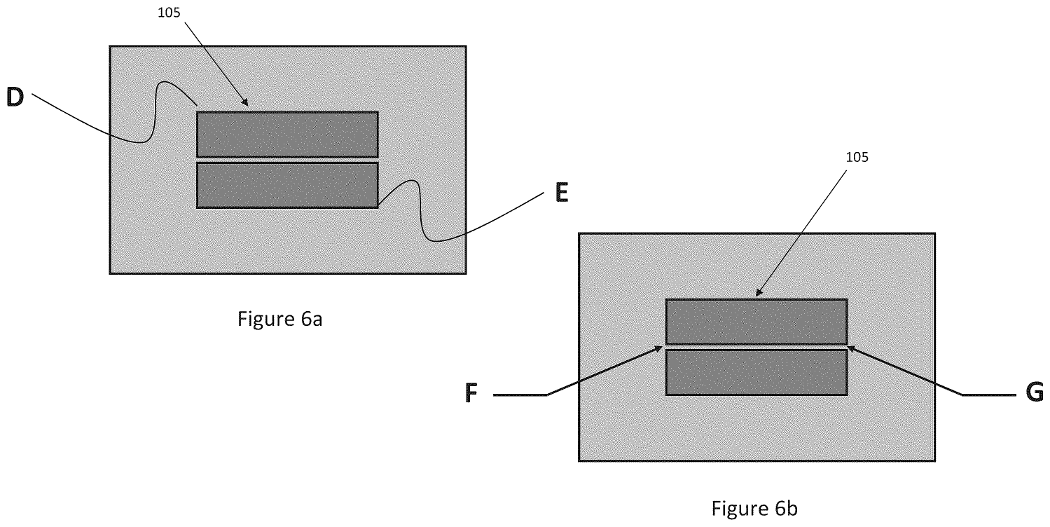

As illustrated in FIG. 6a, with the first option, the software interface will require the user to select the point along the edge of the target workpiece in the image. For example, points D or E. The user can use this method in any optical condition, even though there are shades in the image, or the image quality is not good enough.

### IIB: Target Boundary

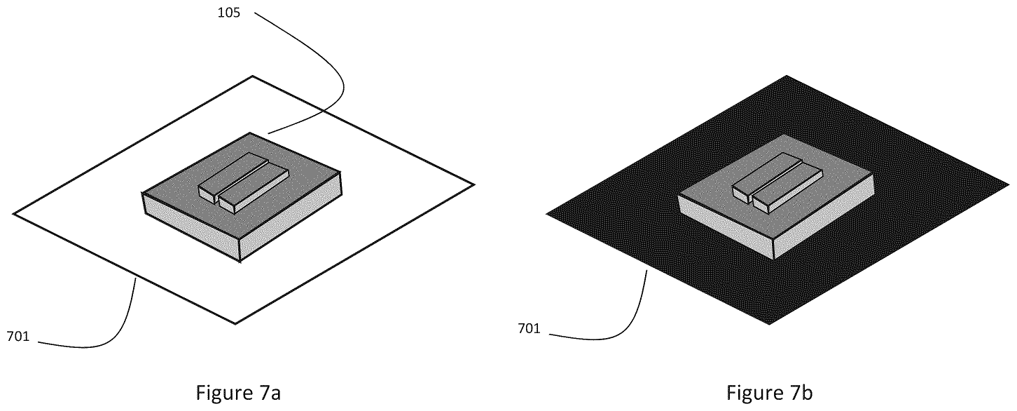

As illustrated in FIGS. 7a and 7b, with the second option the boundary of the workpieces is automatically generated in the image with an image-processing algorithm. This method requires a uniform color background image. The user must place the workpiece on top of a white or dark color sheet 701 to take a picture. For workpieces with simple shapes, the second option is recommended.

### III: Reference Trajectory Programming

As illustrated in FIG. 6b, once the user has placed the first reference workpiece on the bench, the waypoints that indicate each weld's start and end position need to be defined. For example, points F or G. The user can move robot arm 103 in free drive mode and place it where needed. After finishing programming, set the robot arm 103 at the image acquisition position and take the reference image of the first part. The algorithm will automatically find the part boundary which the user defined in model generation.

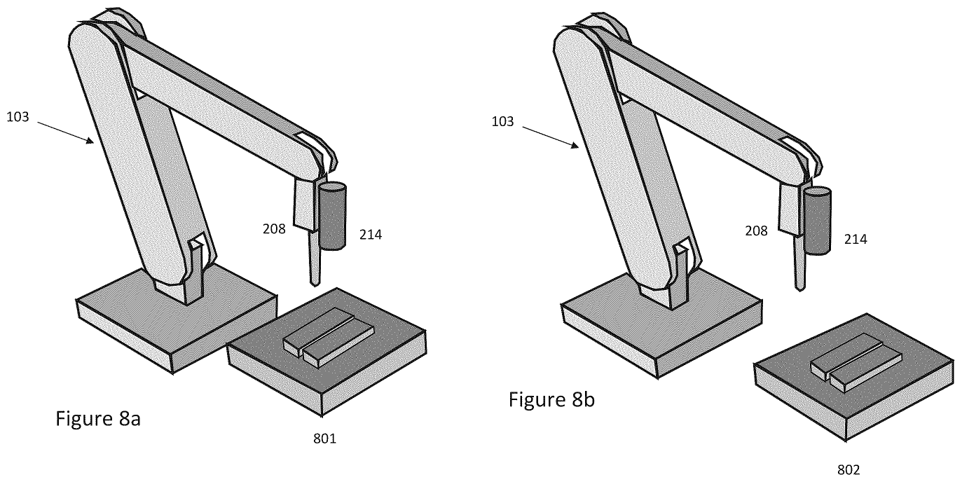

As illustrated in FIGS. 8a and 8b, after finishing welding the first workpiece (801), the user will remove first workpiece 801 and place second workpiece 802 in position. After obtaining the new image, the edge-based algorithm will automatically find the object in the new photo and calculate the displacement of second workpiece 802 relative to the first workpiece 801. The algorithm calculates a new set of waypoints for second workpiece 802 and will be updated automatically. Hence, the vision algorithm can guide robot arm 103 to welding the identical size workpieces in any location on the workbench. The algorithm can also guide robot arm 103 to weld multiple same-size workpieces on the bench. The algorithm can create new trajectories of each part automatically.

### IV: Vision Guided Welding

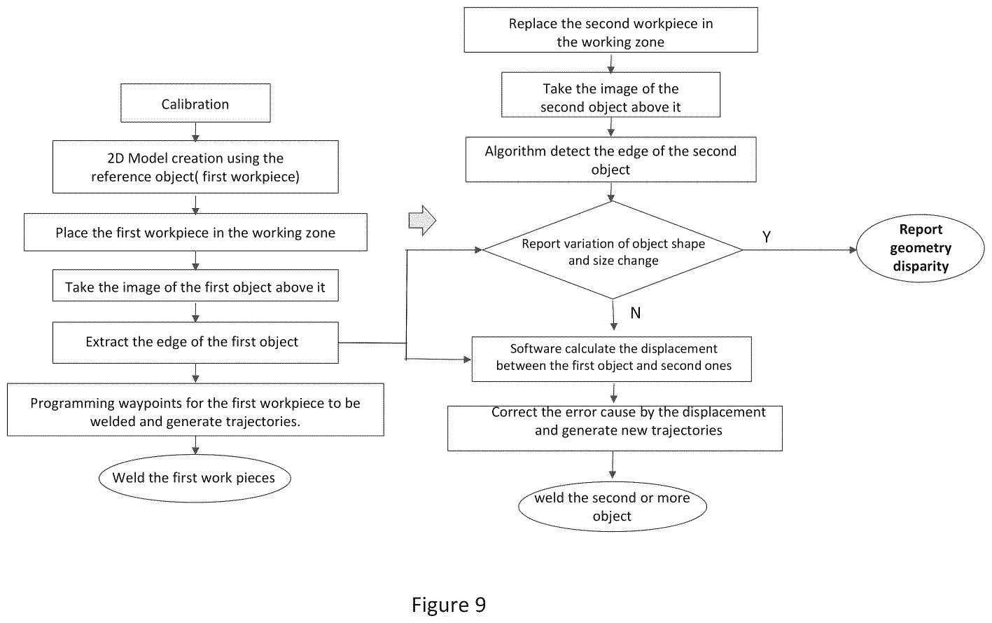

Turning to the process flowchart in FIG. 9, we see the basic steps required for the application of an automatic trajectory for repeatable welding tasks. The system is calibrated as discussed above. Then a 2D model is created using a reference object, which is typically the first workpiece to be welded. The first workpiece is placed on the table in the working zone. The system takes an image of the first object and identifies the required edge. The waypoints for the first workpiece are programed into the system, and the associated trajectories are calculated. The system then utilizes these trajectories to weld the first workpiece.

The first workpiece is removed, and a second workpiece is placed in the working zone. The system takes an image of the second object and identifies the required edge. If the system detects a significant variation in the size or shape of the second object relative to the calibration plate (or first workpiece) this variation is reported, and if necessary, the process is stopped, and this variation is addressed. If no significant variations are detected, the system then calculates the displacement between the first workpiece and the second workpiece. Typically, displacements of greater than 0.5 mm but less than 20 mm in either the x direction or the y direction are acceptable. A rotational displacement of between 0.1 degree and 15 degrees is also generally acceptable. Greater displacements may require relocation of the second workpiece.

The system then adjusts for the displacement and calculates new trajectories. The system then utilizes these trajectories to weld the first workpiece.

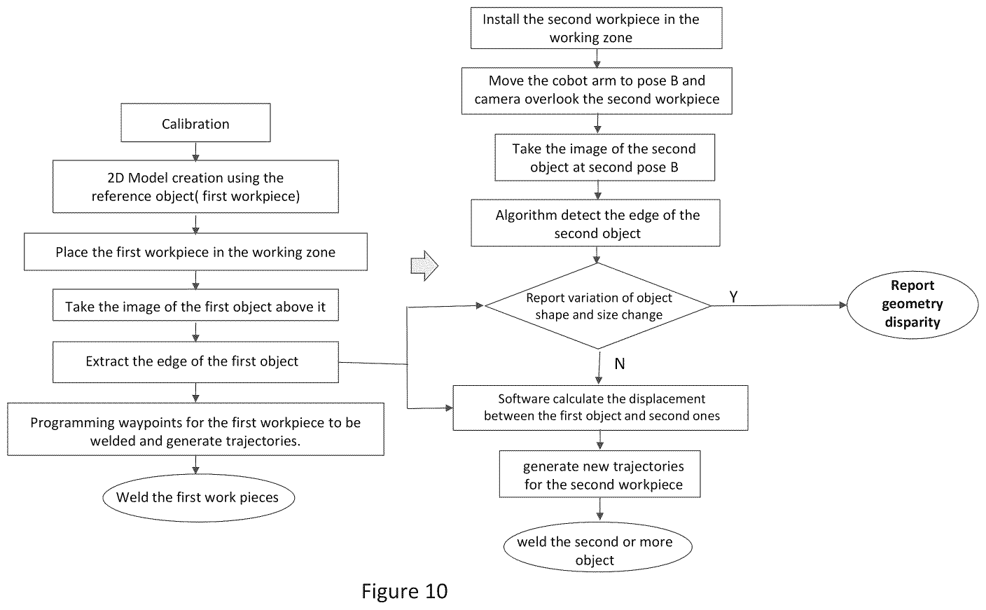

Turning to the process flowchart in FIG. 10, we see the basic steps required for the application of an automatic trajectory for welding tasks involving multiple objects. The system is calibrated as discussed above. Then a 2D model is created using a reference object, which is typically the first workpiece to be welded. The first workpiece is placed on the table in the working zone. The system takes an image of the first object and identifies the required edge. The waypoints for the first workpiece are programed into the system, and the associated trajectories are calculated. The system then utilizes these trajectories to weld the first workpiece.

The first workpiece is removed, and a second workpiece is placed in the working zone. The system relocates the robot arm if necessary and takes an image of the second object and identifies the required edge. If the system detects a significant variation in the size or shape of the second object relative to the calibration plate (or first workpiece) this variation is reported, and if necessary, the process is stopped, and this variation is addressed. If no significant variations are detected, the system then calculates the displacement between the first workpiece and the second workpiece. Typically, displacements of greater than 0.5 mm but less than 20 mm in either the x direction or the y direction are acceptable. A rotational displacement of between 0.1 degree and 15 degrees are also generally acceptable. Greater displacements may require relocation of the second workpiece. The system then adjusts for the displacement and calculates new trajectories. The system then utilizes these trajectories to weld the first workpiece.

### Examples/Data

The user used one of the workpieces as the reference for initial trajectory planning. The user placed the second workpiece 30 cm away from the reference workpiece. Then, the user obtained the photos of the two workpieces before welding, and the algorithm created a new trajectory for the second workpiece. The geometry of the weld bead is close to each other. And both of them passed the inspection. The result shows that the vision system can guide the robot in performing repeatable welding tasks even if the second welding part position is changed.

It will be understood that many additional changes in the details, materials, steps and arrangement of parts, which have been herein described in order to explain the nature of the invention, may be made by those skilled in the art within the principle and scope of the invention as expressed in the appended claims. Thus, the present invention is not intended to be limited to the specific embodiments in the examples given above.

What is claimed is:

1. A compact vision-sensing device for a robotic welding arm, comprising:
a high-resolution camera,
a multi-color light source configured to have multi-color selectivity, and
a means of dust and welding fume protection configured to automatically close and protect the high-resolution camera and multi-color light source during a welding operation.

2. The compact vision-sensing device of claim 1, further comprising a control system configured to control a power source and the movement of the cobotic welding arm.

3. The compact vision-sensing process utilizing the device of claim 2, further comprising a first object to be welded, wherein:
the first object to be welded has a boundary,
the first object to be welded is positioned on a background having uniform color, thereby producing a visual contrast between the boundary of the first object to be welded and the background,
the robot welding arm is configured to be positioned such that the boundary is visible to the high-resolution camera,
wherein the multi-color light source is configured to project light on the boundary,
wherein the high-resolution camera is configured to detect the boundary, thereby producing an image,
wherein the control system is configured to process the image to produce a 2D model of the first object to be welded.

4. A compact vision-sensing process utilizing the device of claim 2, further comprising a first object to be welded, wherein the first object to be welded comprises an edge, wherein:
the robot welding arm is positioned such that the edge is visible to the high-resolution camera,
the multi-color light source is projects light on the edge,
the software detects the edge of the first object in the image, and
the control system processes the image to produce a first 2D model of the first object to be welded.

5. The compact vision-sensing process of claim 4, wherein a user generates a first trajectory.

6. The compact vision-sensing process of claim 5, wherein the software generates a second trajectory for the robotic welding arm including the two or more waypoints.

7. The compact vision-sensing process of claim 4, further comprising:
replacing the first object to be welded with a second object to be welded,
detecting the edge of a second 2D model of the second object to be welded,
calculated the displacement between the edge of the first object to be welded and the second object to be welded,
wherein the minimum measurable displacement is 0.5 mm in x y direction and 0.1 degree for rotation.

8. The compact vision-sensing process of claim 7, wherein the detected edge of the second workpieces is compared to the reference 2D model and any variation in size or shape is reported.

9. The compact vision-sensing process of claim 2, further comprising two or more objects to be welded, wherein the two or more objects to be welded comprise two or more edges, wherein:
the robot welding arm is positioned such that the two or more edges are visible to the high-resolution camera,
the multi-color light source is projects light on the workpieces 105,
the high-resolution camera detects the two or more edges of the two or more objects to be welded.

10. The compact vision-sensing process of claim 7, wherein:
the second object to be welded comprises two or more waypoints that define the welding path,
the software calculates a second trajectory for robotic welding arm including the two or more waypoints based on the 2D model,
the second trajectory comprises a positioning error,
the trajectory corrects the positioning error that is greater than 0.5 mm.

11. The compact vision-sensing process of claim 9, wherein:
the two or more objects to be welded each comprise two or more waypoints that define the welding path,
the calculates a new trajectory for two more objects to be welded.

12. The compact vision-sensing process of claim 3, further comprising:
detecting the 2D edge of the second object to be welded,
calculate the displacement between the first object and the second object wherein the minimum measurable displacement between the first object to be welded and the second object to be welded is 0.5 mm in x and y direction, and 0.1 degree for rotation error

13. The compact vision-sensing process of claim 12, wherein the first 2D model is compared to the edge of the second workpiece, and any variation in size or shape is reported.

14. The compact vision-sensing process of claim 12, wherein:
the second object to be welded comprises two or more waypoints that define the welding path,
the control system calculates a second trajectory for robotic welding arm including the two or more waypoints based on the edge of the second object,
the second trajectory comprises a positioning error,
the trajectory corrects the positioning error that is greater than 0.5 mm.
